(19) United States
(12) Patent Application Publication
(10) Pub. No.: US 2007/0050247 A1
(43) Pub. Date: Mar. 1, 2007

(54) Modifiable and configurable advertising apparatus

(76) Inventor: Juan Carlos Vega, Vienna, VA (US)

Correspondence Address: Raymond C. Jones;Carr, Morris & Graeff, PC, Suite 930, 1120 G St, NW, Washington, DC, 20005, US

(21) Appl. No.: 11/210,768

(22) Filed: Aug. 25, 2005

(51) Int. Cl. G06Q 30/00

(52) U.S. Cl. 705/14

(57) ABSTRACT

An advertising apparatus that may be affixed to a vertical surface, and includes a flat substrate containing a first portion that is capable of being written on, a second portion providing space for a calendar, and a third portion providing space for advertisements from multiple vendors.

### BACKGROUND OF THE INVENTION

1. Field of the Invention

The present invention relates generally to advertisements and advertising media, and more particularly to a modifiable and configurable advertising apparatus usable by consumers at home or the office, which can be updated at periodic intervals.

2. Description of the Related Art

Reaching consumers in a receptive frame of mind is increasingly difficult. As free time decreases and the variety of media vehicles escalates, brands face a constant battle to connect with customers at the most opportune moment. For local vendors, the ability to reach consumers is especially important. Statistics show that the majority of shopping (clothes, groceries, restaurants, home improvements, etc.) takes place within a limited geographic area, essentially within a few miles of the consumer's home or office.

Regarding existing local advertising solutions, many are familiar with the PennySaver publication containing classified ads and advertisements delivered weekly via regular mail. The consumer generally reviews the contents of the PennySaver publication and then cuts out particular coupons for future use and discards the paper. PennySaver also utilizes print and deliver (P&D) flyers, marquee flyers or VIP cards to promote local vendors.

Likewise, many are familiar with the product from ValPak Direct Marketing Systems, Inc. The familiar blue envelope, arriving weekly, delivers targeted marketing coupons and advertisements to nearly 50 million households and businesses across the nation. As with the PennySaver, the consumer reviews the ValPak ads, saving those coupons of interest and discarding the others. ValPak and PennySaver both have web-based ads/coupons as well, which can be viewed online and printed out for later use.

A drawback to the ValPak and PennySaver advertising mediums is that even with weekly mailings, the coupons and advertisements are generally kept out-of-sight for later use. In the fast-paced lifestyles of the most coveted consumers (those with available funds and limited time), the old adage of “out-of-sight, out-of-mind” is particularly apt. For example, when the time comes to order a pizza or Chinese food, consumers invariably waste time searching for the telephone number or a coupon in an overstuffed drawer, or simply forget that they indeed had a coupon.

Many consumers are also familiar with those advertisements from particular vendors that appear each year in December, containing a yearly calendar and advertising space dedicated to the particular vendor. These calendars, however, are of limited use since the ads are for one vendor only.

What is needed therefore, is an advertising apparatus that would be relevant to the consumer, and one which the consumer could display continually and have readily available, near a phone preferably. What is also needed is a modifiable advertising system that can be marketed to multiple local vendors, both new and old, to enable the local vendors to either enter new markets, or solidify existing markets, by paying for advertising space on the advertising apparatus.

### SUMMARY OF THE INVENTION

To overcome the above described and other disadvantages of the prior art, embodiments of the invention described herein provide for an advertising apparatus including a flat substrate containing a first portion that is capable of being written on, a second portion providing space for a calendar, and a third portion providing space for advertisements from multiple vendors.

The flat substrate may be an erasable ink memo board, an erasable chalkboard, or comprise a perforated note pad. The flat substrate may be attached via magnets to a metallic surface, or via two-sided tape to a non-metallic surface. A suitable writing instrument may also be attached, depending on the writing surface.

The calendar and advertisement sections may be pre-printed on the substrate prior to distribution, or they may be detachably attached to the substrate, to allow the calendar and advertisements to be updated periodically.

### BRIEF DESCRIPTION OF THE DRAWINGS

The above objects and other advantages of the present invention will become more apparent by describing in detail the preferred embodiments thereof with reference to the attached drawings in which:

FIG. 1 is a front view of an embodiment of the advertising apparatus of the present invention containing an erasable memo board;

FIG. 2 is a front view of an alternate embodiment of the advertising apparatus of the present invention containing a perforated memo pad;

FIG. 3 is a front view of an alternate chalkboard embodiment of the advertising apparatus of the present invention; and

FIG. 4 is a rear view of an embodiment of the advertising apparatus of the present invention.

### DESCRIPTION OF PREFERRED EMBODIMENTS

The present invention will now be described more fully with reference to the accompanying drawings, in which preferred embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

Broadly described, an embodiment of the invention provides for an advertising apparatus including a flat substrate containing a first portion that is capable of being written on, a second portion providing space for a calendar, and a third portion providing space for advertisements from multiple vendors.

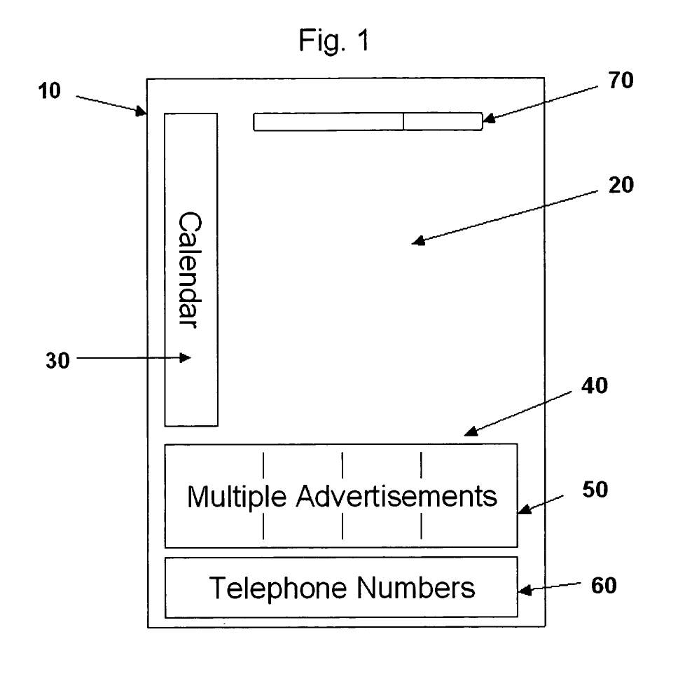

More specifically, as shown in FIG. 1, an embodiment of the advertising apparatus includes a flat substrate 10, preferably an erasable memo board, containing a first portion 20 that is capable of being written on with a suitable erasable maker 70. The flat substrate 10 is preferably 8.5″×11″ in size to provide an efficient writing area, with suitable space remaining for a calendar and advertisements, although other sizes are contemplated. The marker 70 is preferably attached to the flat substrate 10 via a pen-loop type attachment, a string or chain connected to the marker 70, or other suitable and equivalent means.

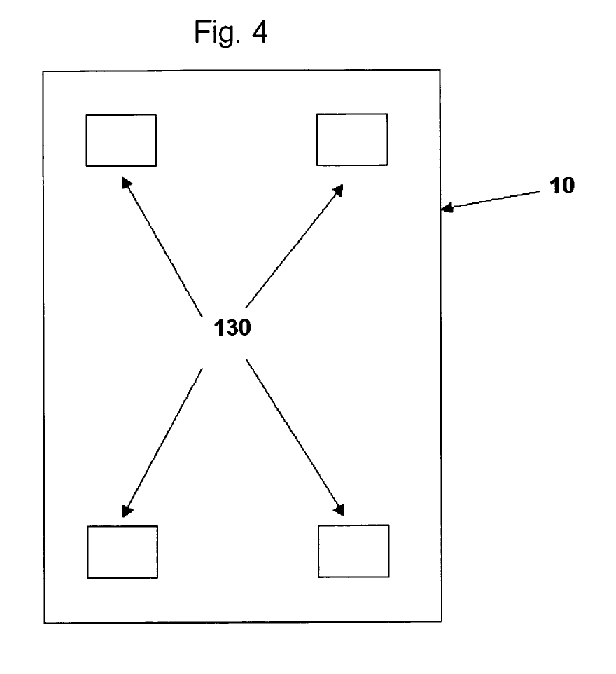

The flat substrate 10 may be affixed to a refrigerator or other vertical metallic surface using a suitable attaching means, such as magnets 130 shown in FIG. 4. In the alternative, flat substrate 10 may be affixed to a vertical non-metallic surface using two-sided tape, hook-and-loop fasteners, or other suitable and equivalent means. Of course, the flat substrate 10 may simply be placed on a horizontal surface, with or without an attaching means.

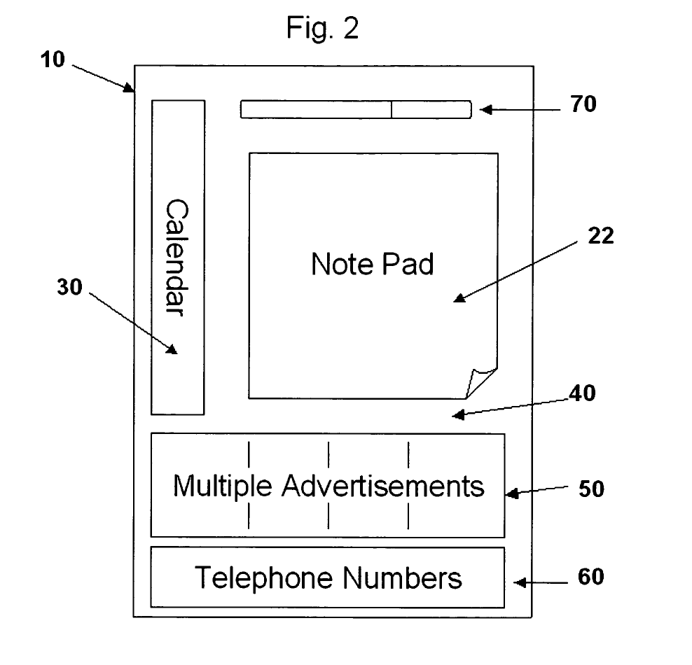

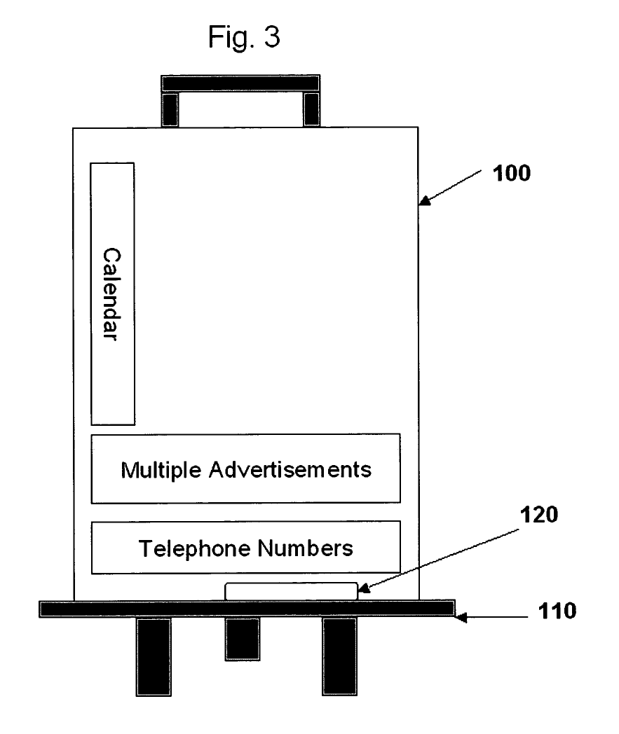

The flat substrate 10 may also be configured with a perforated note pad 22 as the writing surface as shown in FIG. 2. Still further, the flat substrate 10 may also be configured an erasable chalkboard 100 as shown in FIG. 3. If configured as a chalkboard 100, a suitable stand or tripod base 110 to keep the chalkboard 100 in a substantially vertical position, and chalk 120, would be provided to facilitate writing.

The flat substrate 10 contains a second portion providing space for a calendar 30. The calendar 30 may have any periodicity, whether one, three, six, twelve or greater months. The calendar 30 may be printed on the flat substrate 10 prior to distribution. Alternatively, the calendar 30 may be printed separately and attached to the flat substrate 10 by some means to allow replacement, such as with two-sided tape or hook-loop fasteners on the back of the calendar 30. The calendar 30 may also comprise a label-type substrate with an adhesive backing, to be placed over the previous calendar. The calendar 30 imposes an implied expiration date for any advertisement printed on the flat substrate 10 as described further below.

The flat substrate 10 further includes a third portion 40 providing space for color or black-white advertisements from multiple vendors 50, and may also include a separate listing of selected telephone numbers 60 of local vendors. Preferably, the telephone numbers 60 would be listed in a directory style format with the company name and corresponding telephone number.

The advertisements 50 and telephone numbers 60 may be printed on the flat substrate 10 prior to distribution. Alternatively, the advertisements and telephone numbers may be attached to the flat substrate 10 by some means to allow replacement, such as with two-sided tape or hook-loop fasteners on the back. The advertisements and telephone numbers may also comprise a label-type substrate with an adhesive backing, to be placed over the previous advertisements and telephone numbers.

The size of the first, second and third portions may be adjusted to provide more or less space for each task, or be rearranged on the flat substrate as needed prior to distribution. As stated above, the calendar 30 imposes an implied expiration date for any advertisement printed on the flat surface. This allows the distributor of the advertising apparatus to continually update the advertisements, or compile a different list of relevant advertisers, when the calendar 30 itself is updated.

The distributor of the advertising apparatus can implement many different advertising strategies to provide benefits to all parties, including: (i) benefits to the consumer through relevant ads; (ii) benefits to the local vendors by driving consumers to purchase from the vendors after viewing the ads; and (iii) benefits to the distributors themselves, by incorporating current and relevant ads in the advertising apparatus and thereby achieving an above-average rate of advertising revenue.

For example, the display advertisements 50 could have exclusivity, by industry category or cuisine, with a stipulated geographic area. Areas of exclusivity could be determined using zip codes, neighborhood demarcations, store selling and delivery areas, or predetermined distances from specific locations.

Also, limiting the number of company names and corresponding telephone numbers 60 in the directory format at the bottom of the flat substrate 10 could maintain exclusivity. The company name and telephone numbers 60 may or may not have industry exclusivity, and may or may not be in the same categories as the display advertisements 50.

Obviously companies would pay more for exclusive placements, but the distributor of the advertising apparatus would have to balance the desire for greater revenue per ad with the number of relevant ads available in a particular marketplace. For example, if three pizza shops in a college town want to advertise on the advertising apparatus of the present invention, the decreased revenue for the non-exclusivity of each individual ad is offset by an increase in the number of ads and corresponding ad revenue.

The distributor benefits from the revenue received for placing the targeted ads on the advertising apparatus of the present invention, and the advertisers obviously benefit from the present invention by attracting qualified buyers at the most opportune moment. In addition, the consumer benefits for several reasons. First, the ads are continually displayed in a prominent and convenient location in the home or office, usually near the refrigerator. Second, relevant local vendors are easily contacted because the telephone numbers are readily available; no more digging though drawers and address books. Third, the calendar provides useful reference information while on the phone or when coordinating events. Finally, the writing surface provides a handy location for quick messages, notes or reminders.

While the present invention has been described in detail with reference to the preferred embodiments thereof, it should be understood to those skilled in the art that various changes, substitutions and alterations can be made hereto without departing from the scope of the invention as defined by the appended claims.

What is claimed is:

1. An advertising apparatus, comprising:
a flat substrate containing a first portion that is capable of being written on;
a second portion providing space for a calendar; and
a third portion providing space for advertisements from multiple vendors.

2. The apparatus of claim 1, wherein the flat substrate is an erasable ink memo board.

3. The apparatus of claim 1, wherein the flat substrate is an erasable chalk board.

4. The apparatus of claim 1, wherein the flat substrate includes a perforated note pad.

5. The apparatus of claim 1, further comprising a means for attaching the flat substrate to a vertical surface.

6. The apparatus of claim 3, further comprising a tripod base for receiving and orienting the flat substrate in a substantially vertical direction.

7. The apparatus of claim 1, further comprising a writing instrument attached to the flat substrate.

8. The apparatus of claim 1, wherein the advertisements comprise telephone numbers of specific vendors.

9. The apparatus of claim 1, wherein the second portion and third portions are imprinted on the flat substrate.

10. The apparatus of claim 1, wherein the second portion and third portions are detachably attached to the flat substrate.
